(19) United States
(12) Patent Application Publication
(10) Pub. No.: US 2016/0042715 A1
(43) Pub. Date: Feb. 11, 2016

(54) PROJECTION DEVICE, PROJECTION SYSTEM, AND PROJECTION METHOD

(71) Applicant: Atsushi Saitoh, Kanagawa (JP)

(72) Inventor: Atsushi Saitoh, Kanagawa (JP)

(73) Assignee: RICOH COMPANY, LTD., Tokyo (JP)

(21) Appl. No.: 14/820,783

(22) Filed: Aug. 7, 2015

(30) Foreign Application Priority Data
Aug. 8, 2014 (JP) 2014-162917

(51) Int. Cl. G09G 5/00

(52) U.S. Cl. CPC G09G 5/006; G09G 2370/025; G09G 2370/16

(57) ABSTRACT

A projection device is connected to an information processing apparatus via a network. The projection device includes: a communication processing unit that, after transmitting information indicating that connection is possible, receives, from the information processing apparatus, exchange data that includes apparatus identification information for identifying the information processing apparatus and a designated projection mode out of multiple projection modes; an apparatus identifying unit that identifies the information processing apparatus that transmits the exchange data, by using the apparatus identification information included in the received exchange data; a mode switching unit that switches a projection mode of the projection device to the designated projection mode included in the received exchange data; and a projecting unit that, in accordance with the switched projection mode, projects an image received from the identified information processing apparatus.

### CROSS-REFERENCE TO RELATED APPLICATIONS

The present application claims priority to and incorporates by reference the entire contents of Japanese Patent Application No. 2014-162917 filed in Japan on Aug. 8, 2014.

### BACKGROUND OF THE INVENTION

1. Field of the Invention

The present invention relates to a projection device, a projection system, and a projection method.

2. Description of the Related Art

There is a conventionally-known technology with which an information processing apparatus, such as a tablet, is connected to a projection device, such as a projector, via a wireless local area network (LAN) and an image is transmitted from the information processing apparatus to the projection device by using a streaming method so that the image on the screen of the information processing apparatus can be projected by the projection device in real time as it is.

For example, there is the disclosure of a projection system in which, when contents are wirelessly projected, various types of contents information are delivered together with the projection of images (see Japanese Patent Application Laid-open No. 2011-252971). In this projection system, a data projector (a projection device) conducts an image projection that involves visible light communication, while a personal computer receives data contents via the visible-light communication that are included in the projection image and performs a reproduction operation that corresponds to the received data contents.

However, in a case where the screen of the information processing apparatus is projected in real time as it is, it is not possible for conventional projection devices to stand by in multiple wireless LAN connection modes. Therefore, the projection mode of the projection device is previously set to the mode (hereafter, referred to as the streaming mode) in which an image received from the information processing apparatus is projected in real time by using the streaming method, and procedures are conducted to make projection from the information processing apparatus in real time, and only then a state where the image received from the information processing apparatus can be projected by the projection device can be established.

As described above, with conventional projection devices, the procedure for setting the projection mode to the streaming mode is complicated. Furthermore, in a case where an operation on the projection device cannot be performed manually, there is a need to make a switchover to the streaming mode by using a remote controller or the like; thus, the procedure for projecting an image received from the information processing apparatus is further complicated. With the projection system of Japanese Patent Application Laid-open No. 2011-252971, there is a need to provide a device that adds a code to an image and reads them; thus, the procedure for projecting an image in the streaming mode is complicated. Furthermore, as the procedure is complicated, there is a problem in that the frequency at which real-time projection of an image received from the information processing apparatus is used in the projection device decreases so that the utility value of the projection device is reduced.

In view of the foregoing, there is a need to provide a projection device, a projection system, and a projection method with which the procedure for projecting images in real time is simplified so that the utility value is not reduced.

### SUMMARY OF THE INVENTION

It is an object of the present invention to at least partially solve the problems in the conventional technology.

A projection device is connected to an information processing apparatus via a network. The projection device includes: a communication processing unit that, after transmitting information indicating that connection is possible, receives, from the information processing apparatus, exchange data that includes apparatus identification information for identifying the information processing apparatus and a designated projection mode out of multiple projection modes; an apparatus identifying unit that identifies the information processing apparatus that transmits the exchange data, by using the apparatus identification information included in the received exchange data; a mode switching unit that switches a projection mode of the projection device to the designated projection mode included in the received exchange data; and a projecting unit that, in accordance with the switched projection mode, projects an image received from the identified information processing apparatus.

A projection system includes: an information processing apparatus; and a projection device that is connected via a network. The projection device includes a first communication processing unit that, after transmitting information indicating that connection is possible, receives, from the information processing apparatus, exchange data that includes apparatus identification information for identifying the information processing apparatus and a designated projection mode out of multiple projection modes; an apparatus identifying unit that identifies the information processing apparatus that transmits the exchange data, by using the apparatus identification information included in the received exchange data; a mode switching unit that switches a projection mode of the projection device to the designated projection mode included in the received exchange data; and a projecting unit that, in accordance with the switched projection mode, projects an image received from the identified information processing apparatus. The information processing apparatus includes a second communication processing unit that transmits the exchange data to the projection device after receiving the information indicating that the connection is possible.

A projection method is implemented by a projection device that is connected to an information processing apparatus via a network. The projection method includes: after transmitting information indicating that connection is possible, receiving, from the information processing apparatus, exchange data that includes apparatus identification information for identifying the information processing apparatus and a designated projection mode out of multiple projection modes; identifying the information processing apparatus that transmits the exchange data, by using the apparatus identification information included in the received exchange data; switching a projection mode of the projection device to the designated projection mode included in the received exchange data; and projecting, in accordance with the switched projection mode, an image received from the identified information processing apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram that illustrates the overall configuration of a projection system according to an embodiment;

FIG. 2 is a block diagram that illustrates a configuration of a tablet and a projector according to the embodiment;

FIG. 3 is a sequence diagram that illustrates an operation to exchange data between the projector and the tablet;

FIG. 4 is a diagram that illustrates an example of exchange data;

FIG. 5 is a flowchart that illustrates the flow of a projection operation by the projector according to the embodiment;

FIG. 6 is a flowchart that illustrates the flow of the operation to switch the projection mode by the projector according to the embodiment;

FIG. 7 is a diagram that illustrates an example of the hardware configuration of the tablet according to the embodiment; and

FIG. 8 is a diagram that illustrates an example of the hardware configuration of the projector according to the embodiment.

### DETAILED DESCRIPTION OF THE PREFERRED EMBODIMENTS

A detailed explanation is given below, with reference to the attached drawings, of an embodiment of a projection device, a projection system, and a projection method.

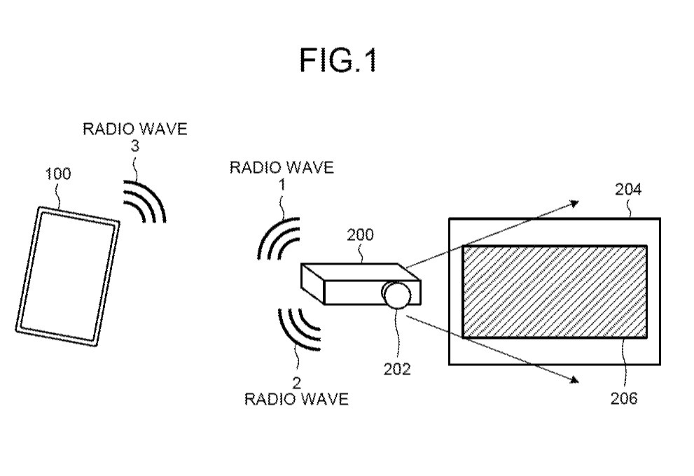

FIG. 1 is a diagram that illustrates the overall configuration of a projection system according to an embodiment. As illustrated in FIG. 1, the projection system according to the present embodiment includes a tablet 100 and a projector 200. The tablet 100 is an example of the information processing apparatus, and the projector 200 is an example of the projection device.

The tablet 100 is a terminal that is capable of transmitting an image to the projector 200 via radio waves by using the streaming method. The streaming method is a method for reproduction of data at the same time as reception thereof when multimedia data, such as images or sounds, is viewed via a network.

The projector 200 receives an image that is transmitted from the tablet 100 by using the streaming method and projects the received image onto a screen 204 via a lens 202 as a projection image 206.

Furthermore, the projector 200 is provided with at least two or more wireless communication pathways (communication pathways) so as to stand by for radio waves like a radio wave 1 and a radio wave 2 that are illustrated in FIG. 1, and it uses the radio waves 1 and 2 to communicate with the tablet 100 via a radio wave 3.

Here, in the illustrated example, the projector 200 according to the present embodiment communicates with the tablet 100 by using the two radio waves (1, 2); however, it is not limited thereto and, it is satisfactory if it is possible to stand by for connection by using two or more wireless communication pathways, such as the combination of an ad hoc mode and a WiFi-Direct mode (the combination of ad hoc connection and WiFi-Direct connection) or the combination of a WiFi-Direct mode and a WiFi-Direct mode (the mutual combination of WiFi-Direct connection). Thus, instead of newly adding the technique of a wireless connection, a conventional wireless connection standard can be used for implementation.

Furthermore, it is assumed that, in order to project an image in the streaming mode (the mode for projecting an image by using the streaming method) according to the present embodiment, the projector 200 stands by for at least one radio wave in the WiFi-Direct mode.

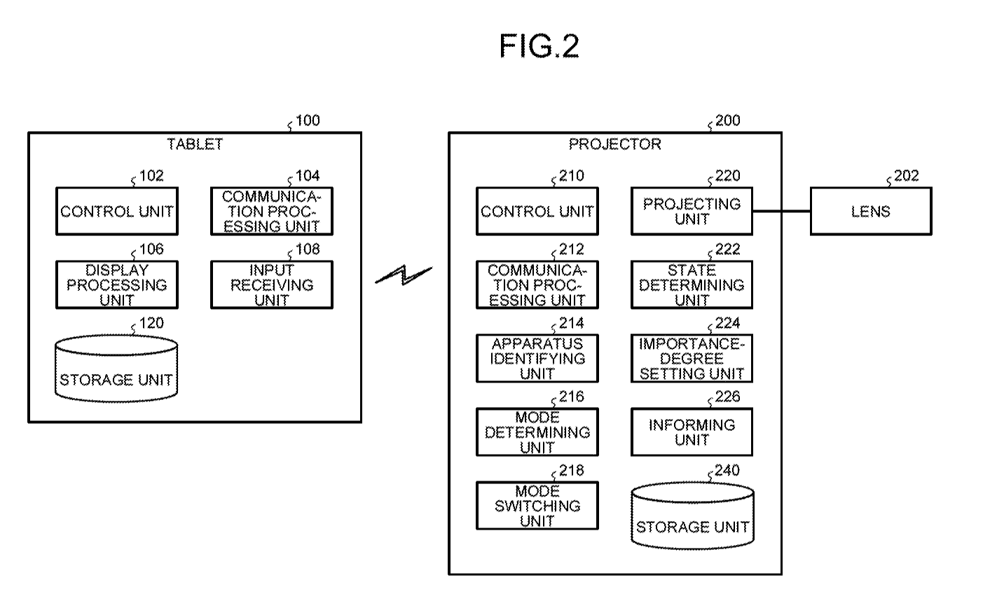

FIG. 2 is a block diagram that illustrates the configuration of the tablet and the projector according to the embodiment. An explanation is first given below of the projector 200. As illustrated in FIG. 2, the projector 200 includes a control unit 210, a communication processing unit 212, an apparatus identifying unit 214, a mode determining unit 216, a mode switching unit 218, a projecting unit 220, a state determining unit 222, an importance-degree setting unit 224, an informing unit 226, and a storage unit 240, and it is provided with the lens 202. The lens 202 is a lens that projects the projection image 206 on the screen 204 as described above.

The storage unit 240 is a storage medium that stores various types of programs and data. The control unit 210 performs the overall control of the projector 200.

The communication processing unit 212 transmits the information indicating that two wireless communication pathways are provided according to the present embodiment as described above and connection is possible by using the two wireless communication pathways, thereby notifying the tablet that the projector 200 is connectable to the tablet. Thus, even if one of the communication pathways is used by a different tablet or the like, the other one of the communication pathways can be used to transmit and receive exchange data to and from the tablet 100.

Next, if connection is established with the tablet 100, the communication processing unit 212 receives, from the tablet 100, the exchange data that includes the identification information (apparatus identification information) for identifying the tablet 100 and the designated projection mode out of multiple projection modes. According to the present embodiment, the communication processing unit 212 receives, from the tablet 100, the exchange data that includes the “media access control address (MAC address)” for identifying the tablet 100 and the “streaming mode” that is the projection mode designated by the tablet 100 and that is the projection mode for projecting the image received from the tablet 100 on the screen 204 (see FIG. 1) by using the streaming method.

Here, the projection mode is the mode for the projector 200 to determine a projection operation during projection of the image that is received from the tablet 100, and there are multiple projection modes. One of the projection modes is the streaming mode (the mode for projecting an image by using the streaming method). According to the present embodiment, when the tablet 100 requests the projector 200 to switch to the streaming mode, the projector 200 switches the projection mode to the streaming mode and projects the image received from the tablet 100 by using the streaming method.

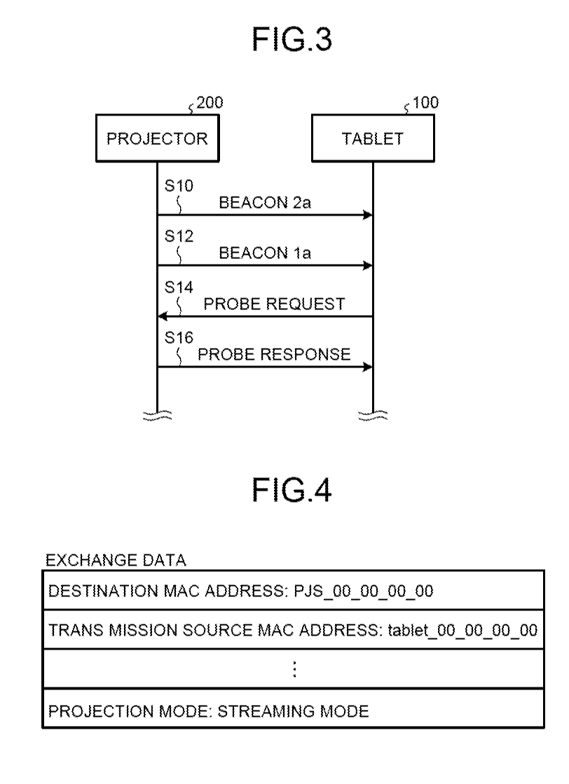

A specific example of an operation to exchange data between the projector 200 and the tablet 100 is described below. FIG. 3 is a sequence diagram that illustrates an operation to exchange data between the projector and the tablet.

The projector 200 and the tablet 100 exchange data via a wireless communication. As illustrated in FIG. 3, the projector 200 according to the present embodiment uses two communication pathways to transmit radio signals (radio waves) of a “Beacon 1a” and a “Beacon 2a” as standby operation (Step S10, Step S12). In this way, the projector 200 informs an unspecified tablet that it is connectable, by using the “Beacon 1a” and the “Beacon 2a”. Here, the “Beacon” is a radio signal that is generated for notification of its presence.

Thus, even if any one of the “Beacon 1a” and the “Beacon 2a” of the projector 200 is used by an undepicted information terminal, the tablet 100 can communicate with the projector 200 by using the other one of the wireless communication pathways. This allows the tablet 100 to find the connectable projector 200.

Next, the tablet 100 transmits a “probe request” to the projector 200 that has been detected by using the “Beacon 1a” or the “Beacon 2a”, which are transmitted from the projector 200, thereby requesting connection using the streaming method (Step S14). Then, if connection is possible by using the streaming method, the projector 200 transmits a “probe response” to respond, and it recognizes that there is the tablet 100 that wants the connection (Step S16).

Here, with reference to the sequence diagram of FIG. 3, an explanation is given of exchange data that is exchanged by using the “probe request” and the “probe response”. FIG. 4 is a diagram that illustrates an example of the exchange data. The exchange data that is exchanged via a wireless communication is not only the information that is illustrated in FIG. 4; however, only the information that is needed for explanations of the present embodiment is here picked up and described.

As illustrated in FIG. 4, the exchange data according to the present embodiment includes the MAC address “PJS_{—}00_{—}00_{—}00_{—}00” that is the identification information of the projector 200 and the MAC address “tablet_{—}00_{—}00_{—}00_{—}00” that is the identification information of the tablet 100. Furthermore, the exchange data according to the present embodiment includes the “streaming mode” that is the projection mode to which the tablet 100 designates the projector 200 to switch. The projector 200 uses the above information in the exchange data to identify the tablet that is the transmission source of the exchange data and determine the projection mode that is designated by the identified tablet.

Furthermore, although not illustrated in FIG. 4, the exchange data can include the timing information that indicates the timing for switching the projection mode of the projector 200 to the designated projection mode. As the timing information is included, it is possible to designate the timing when the projector 200, which receives the exchange data, switches to the projection mode that is designated in the exchange data.

For example, in a case where the exchange data includes the timing information that indicates that the projection mode of the projector 200 is switched if the tablet 100 is identified, the projector 200 identifies the tablet 100, receives the exchange data, and then performs an operation to switch the current projection mode to the designated projection mode. That is, it is possible to make the settings such that, when exchange data is received, the projection mode is automatically switched.

The above automaticity indicates a situation where the projection mode of the projector 200 is switched by using the exchange data that is received by the projector 200 without the need of an operation to switch the projection mode by a user. Thus, as the switching timing can be designated by a user in a detailed manner, the convenience is improved. Furthermore, if the settings are made to the projector 200 such that all determinations are automatically made, the burden on users can be reduced.

Furthermore, the communication processing unit 212 receives the command (switch command) that indicates that the projection mode of the tablet 100 is to be switched to the designated projection mode. For example, if exchange data is received from the tablet 100 and if the timing information included in the exchange data does not indicate the timing for switching the projection mode, the projector 200 stands by without switching the projection mode to the designated projection mode. Afterward, if the projector 200 receives the above-described switch command, the projection mode of the projector 200 is switched to the designated projection mode. Furthermore, the switch command may use a dedicated application, or it may be added to the exchange data illustrated in FIG. 4 and received.

Furthermore, if, in the received exchange data, the designated projection mode is not the projection mode for projecting the image that is received from the tablet 100, i.e., if it is not the streaming mode, the communication processing unit 212 notifies the identified tablet 100 that the image received from the tablet 100 is projectable. This allows a user who does not know how to operate the tablet 100 to prompt the projection. Furthermore, when the image received from the tablet 100 is to be projected, the communication processing unit 212 performs an operation to connect to the tablet 100 and receives the image.

The apparatus identifying unit 214 identifies the tablet 100, which has transmitted the exchange data, on the basis of the identification information such as the MAC address included in the exchange data that is received by the communication processing unit 212.

The mode determining unit 216 determines the projection mode that is designated by the tablet 100 on the basis of various types of information that is included in the exchange data that is received by the communication processing unit 212.

If the exchange data received by the communication processing unit 212 includes the timing information, the mode switching unit 218 switches the projection mode of the projector 200 to the projection mode (the designated projection mode) that is determined by the mode determining unit 216 at the timing that is indicated by the timing information. Therefore, it is possible to designate the switching timing matching the user's usage situation by using the timing information, and the convenience is improved.

Furthermore, if the timing information included in the exchange data does not indicate the timing for switching the projection mode, it means that the timing information indicates that the projection mode is not to be switched, and therefore the mode switching unit 218 stands by without switching the projection mode of the projector 200 to the designated projection mode.

Furthermore, if the command (switch command) that indicates that the projection mode is to be switched is received from the tablet 100, the mode switching unit 218 switches the projection mode of the projector 200 to the projection mode (the designated projection mode) that is determined by the mode determining unit 216 even if it is in a standby state.

If the degree of importance of the image being projected, which is set by the importance-degree setting unit 224 as described later, is higher than a predetermined threshold, and if it is determined by the state determining unit 222 as described later that the projection mode is not to be switched, the mode switching unit 218 does not switch the projection mode of the projector 200 to the projection mode (the designated projection mode) that is determined by the mode determining unit 216.

If the projection mode (the designated projection mode) determined by the mode determining unit 216 is not the streaming mode, the mode switching unit 218 continues the current projection mode without switching the projection mode of the projector 200.

The projecting unit 220 projects, onto the screen 204, the image received from the identified tablet 100 in accordance with the projection mode that is switched by the mode switching unit 218.

The state determining unit 222 determines whether it is in a state where the projection mode of the projector 200 is switchable, on the basis of the degree of importance of the image being projected, which is set by the importance-degree setting unit 224 as described later. Specifically, if the degree of importance of the image being projected is lower than a predetermined threshold, the state determining unit 222 determines that it is in a state where the projection mode of the projector 200 is switchable.

Conversely, if the degree of importance of the image being projected is higher than the predetermined threshold, it is determined that it is not in a state where the projection mode of the projector 200 is to be switched. The projection mode is not switched while the important information is being projected; thus, it is possible to reduce the omission of information transmission or the like.

The importance-degree setting unit 224 sets the degree of importance of an image to be projected. The degree of importance may be set by using any method; however, for example, it is determined by referring to the information that is defined at multiple levels by using a numerical value, and a high degree of importance can be set to the important image information, such as disaster information. Thus, it is possible to prevent automatic switching of the projection mode.

The informing unit 226 gives information if the projection mode of the projector 200 is not switched to the determined projection mode (the designated projection mode) for some reason. Specifically, for example, the informing unit 226 may give information that a switchover is not made to the designated projection mode by using the projection screen of the projector 200 with pop-ups or may give the inform by transmitting it to the tablet 100 using the communication processing unit 212. This allows a user to recognize the reason why a switchover is not made to the designated projection mode.

Next, the tablet 100 is explained. As illustrated in FIG. 2, the tablet 100 includes a control unit 102, a communication processing unit 104, a display processing unit 106, an input receiving unit 108, and a storage unit 120.

The storage unit 120 is a storage medium that stores various types of programs and data. The control unit 102 performs the overall control of the tablet 100 and executes the programs that are stored in the storage unit 120.

The communication processing unit 104 receives, from the projector 200, the information indicating that connection is possible via a wireless communication pathway. Furthermore, if connection is established with the projector 200, the communication processing unit 104 transmits, to the projector 200, the exchange data that includes the apparatus identification information such as the MAC address of the tablet 100 and the projection mode to which the projector 200 is designated to switch. The exchange data may include the above-described timing information.

If the command (switch command) for switching the projection mode is received by the input receiving unit 108, which is described later, from a user, the communication processing unit 104 transmits the switch command to the projector 200. Furthermore, if the designated projection mode in the transmitted exchange data is not the streaming mode, the communication processing unit 104 receives the notification that the image received from the tablet 100 is projectable. Furthermore, if a changeover is not made to the designated projection mode in the projector 200 for some reason, the communication processing unit 104 receives that information from the projector 200.

The display processing unit 106 displays various types of information on a display unit. According to the present embodiment, the display processing unit 106 displays, on the display unit, the notification, which is received from the communication processing unit 104, that the image received from the tablet 100 is projectable. Furthermore, the display processing unit 106 displays, on the display unit, the information, which is received from the communication processing unit 104, that a switchover is not made to the designated projection mode in the projector 200 for some reason.

The input receiving unit 108 receives various types of information from an input unit. According to the present embodiment, the input receiving unit 108 receives, from a user, the command for switching the projection mode of the projector 200 or the command for the timing for switching the projection mode.

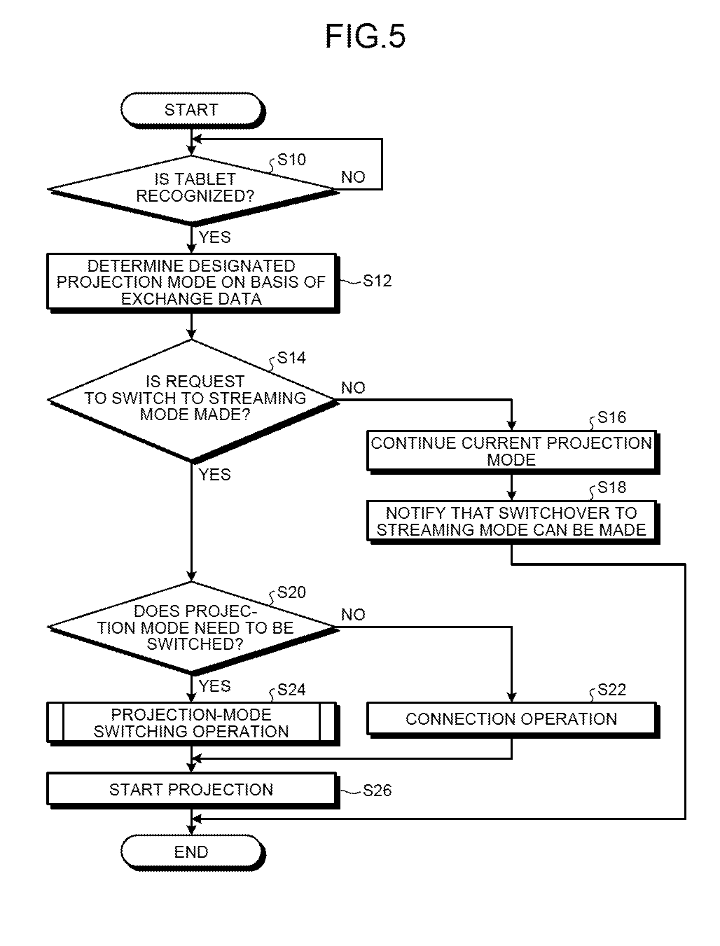

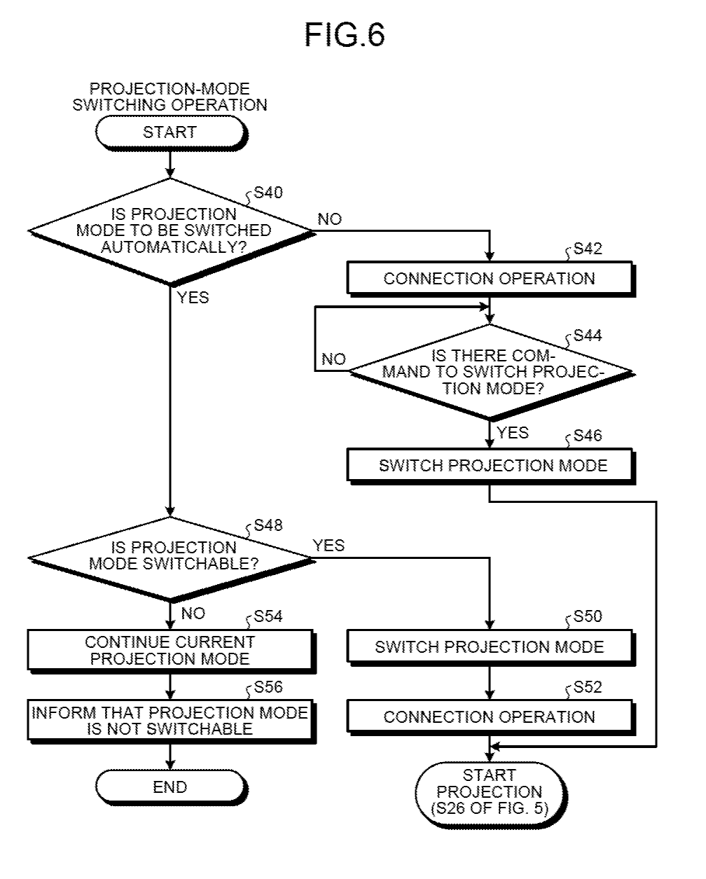

Next, an explanation is given of the flow of an operation during which the projector 200 receives exchange data from the tablet 100, switches the projection mode, and then starts projection in the projection system according to the present embodiment. FIG. 5 is a flowchart that illustrates the flow of a projection operation by the projector according to the embodiment.

First, the projector 200 determines whether it recognizes the tablet 100 that transmits the image to be projected (Step S10) and, if it is not recognized (Step S10: No), it continues to stand by.

Conversely, if the tablet 100 is recognized (Step S10: Yes), i.e., if the apparatus identifying unit 214 identifies the tablet 100 that transmits the exchange data that is received by the communication processing unit 212, the mode determining unit 216 determines the designated projection mode on the basis of the received exchange data (Step S12).

Then, the mode switching unit 218 determines whether a request to switch to the streaming mode is made to the projector 200, on the basis of the determined projection mode (the designated projection mode) (Step S14).

If a request to switch to the streaming mode is not made (Step S14: No), the mode switching unit 218 continues the current projection mode without switching the projection mode of the projector 200 (Step S16). Then, the communication processing unit 212 notifies the tablet 100 that the projection mode is switchable to the streaming mode, i.e., the image received from the tablet 100 is projectable (Step S18) and terminates the operation.

Conversely, if a request to switch to the streaming mode is made (Step S14: Yes), the mode switching unit 218 determines whether the projection mode needs to be switched (Step S20).

If the projection mode does not need to be switched (Step S20: No), i.e., if the streaming mode has been already set, the communication processing unit 212 performs an operation to connect to the tablet 100 (Step S22). Then, the projecting unit 220 starts to project the image that is received from the tablet 100 (Step S26).

Conversely, if the projection mode needs to be switched (Step S20: Yes), the mode switching unit 218 performs an operation to switch the projection mode (Step S24). The operation to switch the projection mode will be described in detail with reference to FIG. 6. Then, the projecting unit 220 starts to project the image that is received from the tablet 100 (Step S26).

Here, at Step S18, the communication processing unit 212 provides notification that the projection mode is switchable to the streaming mode; however, the settings may be made such that the above notification operation is not performed.

Next, an explanation is given of the details of the operation to switch the projection mode at Step S24. FIG. 6 is a flowchart that illustrates the flow of the operation to switch the projection mode by the projector according to the embodiment.

If the projection mode needs to be switched at Step S20 of FIG. 5, the mode switching unit 218 determines whether the projection mode is to be automatically switched (Step S40). Specifically, the mode switching unit 218 determines whether the timing information included in the received exchange data indicates that the projection mode is to be switched if the tablet 100 is identified.

If the projection mode is not switched automatically (Step S40: No), i.e., if the timing for switching the projection mode is not indicated by the timing information, the communication processing unit 212 performs an operation to connect to the tablet 100 (Step S42).

Furthermore, the mode switching unit 218 determines whether the communication processing unit 212 receives a command to switch the projection mode (Step S44). If a command to switch the projection mode is not received (Step S44: No), a stand-by state is continued.

Conversely, if a command to switch the projection mode is received (Step S44: Yes), the mode switching unit 218 switches the projection mode of the projector 200 to the streaming mode that is designated by the tablet 100 (Step S46) and returns to the start of projection (FIG. 5, Step S26).

At Step S40, if the projection mode is to be switched automatically (Step S40: Yes), i.e., if the timing information indicates that a changeover to the projection mode is to be made if the tablet 100 is identified, the state determining unit 222 determines whether the projection mode of the projector 200 is switchable (Step S48). The state determining unit 222 makes the determination on the basis of whether, for example, the degree of importance of the image being projected is higher than a predetermined threshold.

If the projection mode of the projector 200 is switchable (Step S48: Yes), i.e., if the degree of importance of the image being projected is lower than the predetermined threshold, the mode switching unit 218 switches the projection mode of the projector 200 to the streaming mode that is designated by the tablet 100 (Step S50). Then, the communication processing unit 212 performs an operation to connect to the tablet 100 (Step S52) and returns to the start of projection (FIG. 5, Step S26).

Conversely, if the projection mode of the projector 200 is not switchable (Step S48: No), i.e., if the degree of importance of the image being projected is higher than the predetermined threshold, the mode switching unit 218 does not switch the projection mode, and the current projection mode is continued (Step S54). Then, the informing unit 226 gives information that the projection mode is not switchable to the streaming mode (Step S56), and the operation is terminated.

As described above, in the projection system according to the present embodiment, first, the tablet 100 and the projector 200 recognize each other by transmitting and receiving exchange data. Afterward, on the basis of the designated projection mode included in the exchange data and the timing information that indicates the timing for switching the projection mode, the projector 200 switches to the designated projection mode (the streaming mode) at the timing that is indicated by the timing information from the tablet 100 and projects the image received from the tablet 100 on the projector 200 in real time.

Thus, even if the projector 200 stands by in a projection mode other than the projection mode (the streaming mode) in which the image received from the tablet 100 can be projected in real time, the projector 200 automatically switches the projection mode to the streaming mode without manual switching to the streaming mode, thereby projecting the image received from the tablet 100 in real time. Furthermore, as multiple wireless communication pathways are simultaneously activated, even if there is an in-use wireless communication pathway, an unused wireless communication pathway can be used to receive exchange data from the tablet 100. Thus, the procedure for projecting the image received from the tablet 100 in real time by the projector 200 is simplified, and the utility value is not reduced.

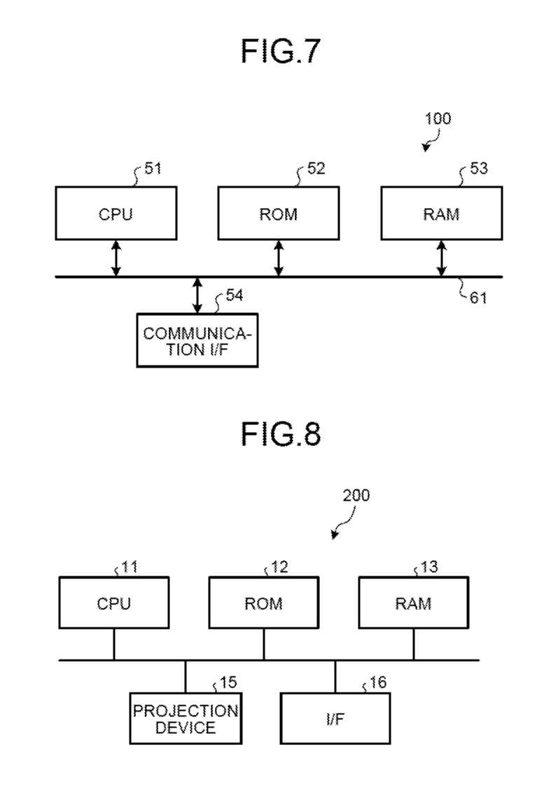

Next, with reference to FIG. 7, an explanation is given of the hardware configuration of the tablet according to the embodiment. FIG. 7 is a diagram that illustrates an example of the hardware configuration of the tablet according to the embodiment. As illustrated in FIG. 7, the tablet 100 according to the embodiment includes a control device, such as a central processing unit (CPU) 51, a storage device, such as a read only memory (ROM) 52 or a random access memory (RAM) 53, a communication I/F 54 that connects to a network for communication, an external storage device, such as a hard disk drive (HDD) or a compact disc (CD) drive device, a display device, such as a display, an input device, such as a keyboard or a mouse, and a bus 61 that connects the units, and it has a hardware configuration that uses a commonly used computer.

Next, with reference to FIG. 8, an explanation is given of the hardware configuration of the projector according to the embodiment. FIG. 8 is a diagram that illustrates an example of the hardware configuration of the projector according to the embodiment. As illustrated in FIG. 8, the projector 200 includes a CPU 11, a ROM 12, a PRAM 13, a projection device 15, and an I/F 16. Among them, the CPU 11 performs the overall control of the projector 200. The ROM 12 stores programs and various types of data that are used during an operation that is performed under the control of the CPU 11. The RAM 13 temporarily stores data, or the like, that is used during an operation that is performed under the control of the CPU 11. The projection device 15 projects a content image that is developed on the RAM 13. The I/F 16 communicates various types of data with an external device, or the like. The I/F 16 is an interface for, for example, an infrared communication, a universal serial bus (USB), a local area network (LAN), or IEEE1394.

A projection program to be executed by the projection system according to the present embodiment is provided by being stored, in the form of a file that is installable and executable, in a recording medium readable by a computer, such as a CD-ROM, a flexible disk (FD), a CD-R, or a digital versatile disk (DVD).

Furthermore, a configuration may be such that the projection program to be executed by the projection system according to the present embodiment is stored in a computer connected via a network such as the Internet and provided by being downloaded via the network. Furthermore, a configuration may be such that the projection program to be executed by the projection system according to the present embodiment is provided or distributed via a network such as the Internet. Moreover, a configuration may be such that the projection program according to the present embodiment is provided by being previously installed in a ROM, or the like.

The projection program to be executed by the projection system according to the present embodiment has a modular configuration that includes the above-described units and, in terms of the actual hardware, the CPU (processor) reads the projection program from the above-described recording medium and executes it so that the above-described units are loaded into a main storage device and each of the above-described units is generated in the main storage device. Furthermore, for example, all or part of the functions of the above-described units may be implemented by using a dedicated hardware circuit.

Furthermore, the embodiment is not intended to limit the scope of the present invention, and a configuration may be such that a server, or the like, connected via a network includes a part of the functions (e.g., the apparatus identifying unit or the mode switching unit) of the projection device and the information processing apparatus. Here, the system configuration for connecting the projection device and the information processing apparatus as described in the embodiment is an example, and it is obvious that there are various system configuration examples depending on usages or purposes.

An embodiment provides an advantage that the procedure for projecting an image in real time is simplified and the utility value is not reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A projection device that is connected to an information processing apparatus via a network, the projection device comprising:
a communication processing unit that, after transmitting information indicating that connection is possible, receives, from the information processing apparatus, exchange data that includes apparatus identification information for identifying the information processing apparatus and a designated projection mode out of multiple projection modes;
an apparatus identifying unit that identifies the information processing apparatus that transmits the exchange data, by using the apparatus identification information included in the received exchange data;
a mode switching unit that switches a projection mode of the projection device to the designated projection mode included in the received exchange data; and
a projecting unit that, in accordance with the switched projection mode, projects an image received from the identified information processing apparatus.

2. The projection device according to claim 1, wherein the communication processing unit is provided with multiple communication pathways and transmits the information indicating that the connection is possible, by using the multiple communication pathways.

3. The projection device according to claim 1, wherein
the exchange data further includes timing information that indicates a timing for switching the projection mode of the projection device, and
the mode switching unit switches the projection mode of the projection device to the designated projection mode at the timing that is indicated by the timing information included in the received exchange data.

4. The projection device according to claim 3, wherein the timing information indicates that the projection mode of the projection device is to be switched when the information processing apparatus is identified.

5. The projection device according to claim 3, wherein
if the timing for switching the projection mode is not indicated by the timing information, the mode switching unit stands by without switching the projection mode of the projection device to the designated projection mode,
the communication processing unit further receives a command to switch the projection mode of the projection device, and
if the command is received, the mode switching unit switches the projection mode of the projection device to the designated projection mode.

6. The projection device according to claim 1, further comprising an importance-degree setting unit that sets a degree of importance of an image to be projected, wherein
if the degree of importance of an image being projected is higher than a predetermined threshold, the mode switching unit does not switch the projection mode of the projection device to the designated projection mode.

7. The projection device according to claim 6, further comprising an informing unit that gives information if the projection mode of the projection device is not switched to the designated projection mode.

8. The projection device according to claim 1, wherein, if the designated projection mode is not a projection mode for projecting an image received from the information processing apparatus, the communication processing unit notifies the identified information processing apparatus that the image received from the information processing apparatus is projectable.

9. The projection device according to claim 2, wherein the communication pathways are a combination of ad hoc connection and WiFi-Direct connection or a mutual combination of WiFi-Direct connection.

10. A projection system comprising:
an information processing apparatus; and
a projection device that is connected via a network, wherein
the projection device includes
a first communication processing unit that, after transmitting information indicating that connection is possible, receives, from the information processing apparatus, exchange data that includes apparatus identification information for identifying the information processing apparatus and a designated projection mode out of multiple projection modes;
an apparatus identifying unit that identifies the information processing apparatus that transmits the exchange data, by using the apparatus identification information included in the received exchange data;
a mode switching unit that switches a projection mode of the projection device to the designated projection mode included in the received exchange data; and
a projecting unit that, in accordance with the switched projection mode, projects an image received from the identified information processing apparatus, and
the information processing apparatus includes a second communication processing unit that transmits the exchange data to the projection device after receiving the information indicating that the connection is possible.

11. A projection method that is implemented by a projection device that is connected to an information processing apparatus via a network, the projection method comprising:
after transmitting information indicating that connection is possible, receiving, from the information processing apparatus, exchange data that includes apparatus identification information for identifying the information processing apparatus and a designated projection mode out of multiple projection modes;
identifying the information processing apparatus that transmits the exchange data, by using the apparatus identification information included in the received exchange data;
switching a projection mode of the projection device to the designated projection mode included in the received exchange data; and
projecting, in accordance with the switched projection mode, an image received from the identified information processing apparatus.
